(19) United States
(12) Patent Application Publication
(10) Pub. No.: US 2010/0148098 A1
(43) Pub. Date: Jun. 17, 2010

(54) DIRECTLY PILOTED VALVE ASSEMBLY

(76) Inventor: Vytautas J. Toliusis, Paw Paw, MI (US)

Correspondence Address: KING & SCHICKLI, PLLC, 247 NORTH BROADWAY, LEXINGTON, KY, 40507, US

(21) Appl. No.: 12/567,242

(22) Filed: Sep. 25, 2009

Related U.S. Application Data
(60) Provisional application No. 61/102,427, filed on Oct. 3, 2008.

(51) Int. Cl. F16K 31/12

(52) U.S. Cl. 251/30.01

(57) ABSTRACT

A directly piloted valve assembly has a valve body including a bore, at least one inlet port, at least one outlet port and at least one exhaust port wherein the ports are all in fluid communication with the bore. A spool is received in the bore. The spool includes a wall defining a lumen. An actuator is received in the lumen. The actuator includes a shuttle seal channel. A shuttle seal is received in the shuttle seal channel. A solenoid is connected to the valve body. The wall of the spool includes at least one pilot hole in fluid communication with the lumen defined by the spool and the bore of the valve body.

This application claims the benefit of U.S. Provisional Patent application Ser. No. 61/102,427 filed on 3 Oct. 2008, the full disclosure of which is incorporated herein by reference.

### TECHNICAL FIELD

The present invention relates generally to the pneumatic valve field and, more particularly, to a directly piloted valve assembly.

### BACKGROUND OF THE INVENTION

Generally speaking there are two main valve types, direct acting designs and piloted designs. With a direct acting solenoid design the movable armature is in direct contact with and directly pushes or pulls the main valve shifting element, typically called the spool or stem. After shifting, the spool or stem is returned by the force of a return spring or a second solenoid, for a double solenoid valve. Sealing elements on the stem are typically of the poppet configuration. Poppet seats allow for a shorter stroke of the spool for a given amount of flow gap between the poppet and seat.

A sliding seal on the spool would require a much longer stroke of the spool because now the sealing element has to move far enough to create the flow gap and enter into the sealing bore. Sliding seals that enter and exit a bore are typically not used with the direct acting design because the long stroke and high seal friction forces would require high solenoid power levels. There are designs that compensate for this force distance limitation by having sealing elements with extremely low friction forces. The trade off is that this design has a constant low level leaking because sealing is accomplished by close fitting metal components. The sliding metal to metal elements must always have a clearance to maintain low shifting force and so the always present gap has an always present leak.

Another limitation of the direct acting design is the requirement of tight tolerances in positioning the poppet relative to the poppet seat. Typically this is accomplished as a part of the assembly process. Each valve is assembled with its own unique positioning of poppets on the spool. This requirement is most demanding for the 4-way valve because two (2) poppets must seal at the same time. Sealing both poppets at the same time is made more difficult because one poppet seals with pressure and the other seals against pressure. Thus, one poppet is forced into the sealing gap by pressure and the other is being forced out of the sealing gap. In addition to the tight positional tolerances of mating components, the seats in the body must be precisely machined. Seat finish has to be smooth with no dings, dents or rough machine marks and radius of seat has to be within a tight tolerance, typically around 0.007/0.003. If the seat is too large, the valve will not seal at high pressure and if the seat is too small (sharp), the poppet will be cut causing early failure.

Another approach is to make the mating components to tight tolerances. This can involve the machining of the elastomeric poppet material that has been molded onto the spool. Advantages of direct acting design are: (1) there is no minimum operating pressure limitation; (2) typically it will function with vacuum and pressure; and (3) total part count is less than piloted design. Disadvantages of the direct acting design are: (1) relatively low ratio of flow to solenoid power (watts), *Cv/watt (a higher ratio valve would require less power for the same flow); (2) cost of manufacturing parts to tight tolerance or making assembly settings to tight positional tolerances because of inability to machine to required tolerances; (3) for the custom assembled version parts can not be changed or replaced (product is not repairable and typically valve coil can not be changed when a different voltage is needed); and (4) for products machined to tight tolerances only, not needing custom assembly, coils can be changed but the spool cannot because insertion of the spool requires special tooling.

The typical piloted valve is really two valves, combining a larger high flow 4-way or 3-way valve body with a smaller 3-way valve that is typically attached at one or both ends of the larger body. The smaller 3-way valve provides an air pilot signal that acts on a pilot piston of the larger valve to shift a spool. Return of the spool can be accomplished with either air pressure or a return spring or a combination of both. This design results in relatively high flow with lower power consumption than a direct acting valve.

Advantages of the piloted design include: (1) much greater flow than the direct acting because spool stroke is not limited by coil power, has high ratio of Cv/watts; (2) components can be replaced to repair valve or change coil voltage; and (3) does not require tolerances as tight as those of the direct acting design.

Disadvantages of the piloted design include: (1) part count is high because two valves are required, pilot and main valve; (2) final product is longer, more components than a direct acting product; (3) there is a minimum pilot pressure required for pilot function, around 30 psi; (4) slower response than direct acting; (5) higher cost of valve body due to requirement of connecting pilot valve output to pilot piston and supply pressure to the return piston. This is done with cross drillings that are plugged with balls or synthetic elastomer seals; (6) can not be used with vacuum unless separate pilot pressure is supplied; (7) different bodies must be machined for different pilot port sources; (8) power of 3-way pilot valve is determined by orifice size of the pilot valve. Pilot valves have very low Cv values because forces of the solenoid armature and return spring have to be greater than the product of the orifice size and pressure (area X pressure). The small orifice size allows for lower coil power but the trade off is slower main valve response due to reduced flow to and exhaust from pilot pistons; and (9) spool requires 6 seals to prevent extrusion.

The present invention relates to a directly piloted valve assembly. The primary unique feature in this design is that the solenoid actuator/armature in combination with the spool directly creates the pilot function that shifts the spool. There is no 3-way pilot valve that has to be mounted to the body and have its outputs routed into the body with plugged drillings. Pilot pressure shifts the spool while opposite end of spool is open to exhaust to the atmosphere. The typical piloted valve has a larger pilot piston exerting a force against a smaller return piston and both are at the same pressure. This arrangement results in slower spool movement due to added friction forces of pilot piston seals and back pressure of air having to exhaust back through the restricted orifice of the pilot valve.

Advantages of directly piloted design include: (1) lower product component costs because pilot function is achieved with the spool and actuator/armature. A 3-way pilot valve and pilot end cap are not used; (2) fast response because end of spool opposite pilot pressure action is open to atmosphere (it is not opposed by the force of a smaller return piston or a return spring so pilot force does not have to overcome the seal friction of two pilot piston seals); (3) lower assembly cost because parts are assembled as machined, to achievable tolerances (design does not require custom setting of components); (4) has lower minimum operating pressure because of spool seal design and because spool requires only four seals not the typical six seal spool design. Another contributing factor to low minimum operating pressure is that the pilot signal does not have to work against a return force. Minimum rated pressure will be around 10 psi. The typical piloted valve requires 20 to 40 psi. to function. This leads to other advantages; (5) critical machining tolerances in body and coil holder can be easily maintained by using custom finish form tools. Also the tolerance stack up between critical features is eliminated by using a common plane for positioning critical features of the coil holder and body washer to the body; (6) low solenoid power requirement because actuator/armature stroke is short (0.010 to 0.015 inches) and pneumatic forces acting on actuator/armature are balanced (pressure does not force actuator in either direction, so effective pilot orifice size is not a limiting factor to keeping coil power low so pilot function has higher Cv/watts ratio than the typical pilot valve); (7) higher flow is possible than with the typical piloted valve because more of the body length is available for spool stroke due to using only 4 spool seals instead of the typical 6; (8) the same body can be used to supply pilot pressure from different ports by using different spool/actuator pairs (the typical piloted valves requires a different body); and (9) poppet action of actuator quad rings at body seal end and coil washer end is always sealing with the pressure (this allows for the use of off the shelf quad rings instead of custom molded and bonded poppets).

Disadvantages of directly piloted design include: (1) has a minimum operating pressure; (2) can not work with vacuum unless separate pilot pressure is supplied; and (3) spool and actuator parts must be machined differently to supply pilot pressure from different ports.

In summary the only significant disadvantage of this new design when compared to the direct acting product is that it does have a minimum operating pressure. However, it has many advantages over both a direct acting product and a piloted product. When compared only to the piloted product its minimum operating pressure is significantly lower, 10 psi. verses 20 to 40 psi. for the typical piloted valve. For many applications that use a direct acting valve instead of a piloted one because of the minimum operating pressure limitation, this new directly piloted design could be used.

### SUMMARY OF THE INVENTION

In accordance with the purposes of the present invention as described herein, a directly piloted valve assembly is provided. That directly piloted valve assembly comprises: a valve body including a bore, at least one inlet port, at least one outlet port and at least one exhaust port wherein those ports are in fluid communication with the bore; a spool received in the bore where the spool includes a wall defining a lumen; an actuator received in the lumen wherein the actuator includes a shuttle seal channel; a shuttle seal received in the shuttle seal channel and a solenoid connected to the valve body. The wall of the spool includes at least one pilot hole in fluid communication with the lumen and the bore.

More specifically describing the invention, the shuttle seal translate along the actuator between a first end and a second end of the shuttle seal channel. At least one pilot hole is aligned with the shuttle seal channel. That channel has a first width of between about 0.236 and about 0.232 inches. The shuttle seal has a second width of between about 0.063 and about 0.057 inches. A ratio of the first width to the second width is between about 3.68 and about 4.14. Further describing the invention, the solenoid includes a coil and a return spring held in a housing and an armature connected to the actuator.

The actuator includes a first actuator end seal held in a first end channel on a first side of the shuttle seal channel and a second actuator end seal held in a second end channel on a second side of the shuttle seal channel. The first and second actuator end seals are quad ring lobe seals assembled under tension so that an outside diameter of the quad ring lobe seals are enlarged. In addition, the spool includes a first spool end seal, a second spool end seal, a first spool intermediate seal and a second spool intermediate seal. A first annular groove is provided in the spool between the first and second spool intermediate seals. A second annular groove is provided in the spool between the first spool end seal and the first spool intermediate seal. A third annular groove is provided between the second spool end seal and the second spool intermediate seal. At least one pilot hole provides communication between the lumen at the shuttle seal channel and the bore at the first annular groove. That at least one pilot hole has a diameter of between about 0.017 and about 0.015 inches. The actuator has a first stroke having a length L₁ and the spool has a second stroke of a length L₂ where L₂>L₁. Typically the ratio of L₂ to L₁ is between about 13.7 and about 9.7.

In one particularly useful embodiment the shuttle seal is a quad ring lobe seal. That quad ring lobe seal includes an annular groove, between lobes, aligned with at least one pilot hole when the spool and the actuator are in a first operating position and a second, opposite operating position. In addition, the invention includes two radial relief grooves in the actuator wall and communicating with the lumen. One of those two radial relief grooves is provided on each side of the pilot hole so that the shuttle quad ring lobe seal is also axially centered between the two radial relief grooves when the spool and the actuator are at the first and second operating positions. Still further it should be appreciated that the first spool end seal, second spool end seal, first spool intermediate seal and second spool intermediate spool may all be quad ring lobe seals. All of these quad ring lobe seals on the spool are provided in tension so as to be pulled toward the center of the spool so that the two outer lobes are at different diameters.

In accordance with yet another aspect of the present invention a fourth annular groove may be provided on the actuator between the first actuator end seal and the shuttle seal channel. Further, a fifth annular groove may be provided on the actuator between the second actuator end seal and the shuttle seal channel. Still further, the valve assembly includes piloting guides at two ends of the actuator to allow air to pass to atmosphere.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a perspective view of the valve assembly of the present invention;

FIGS. 2, 2a, 3, 4a, 4b, 5a, 5b and 5c are combined cross sectional and detailed cross sectional views fully illustrating the operation of the valve assembly of the present invention illustrated in FIG. 1;

FIG. 6 is a detailed cross sectional view further illustrating beneficial features of the valve assembly of the present invention;

FIG. 7 is a cross sectional view of a four-way, five-ported directly piloted valve assembly constructed in accordance with the teachings of the present invention; and

FIG. 8 illustrates a three-may, normally closed, directly piloted valve assembly constructed in accordance with the teachings of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

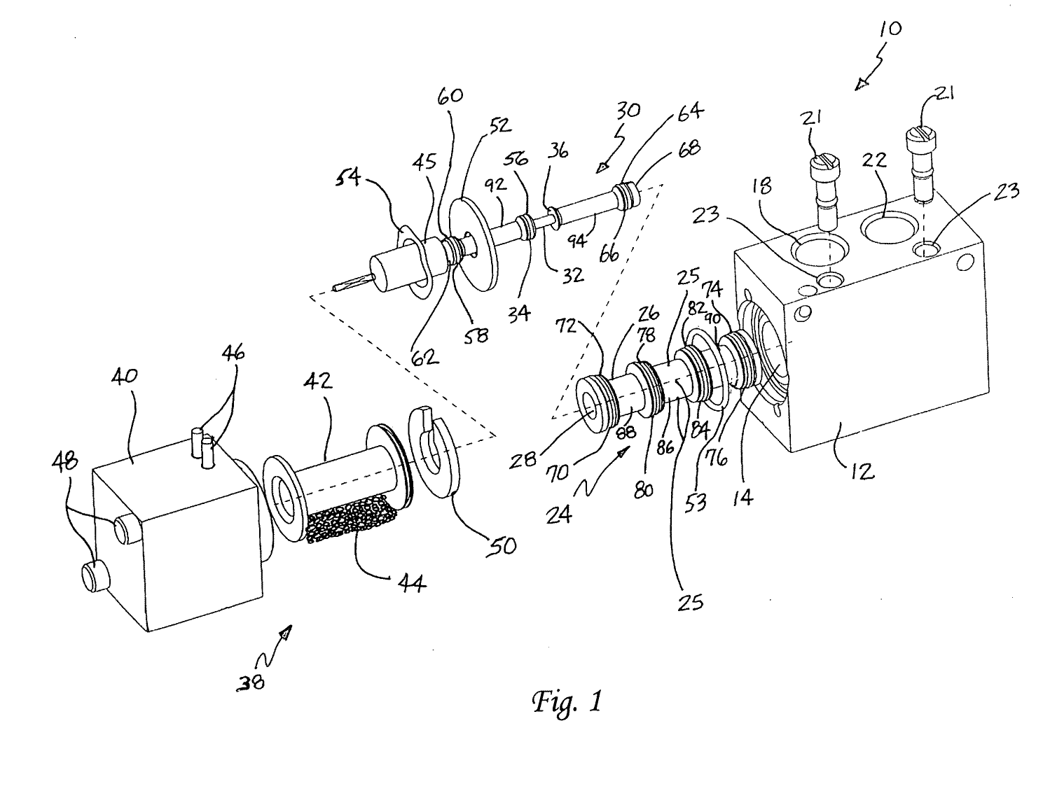

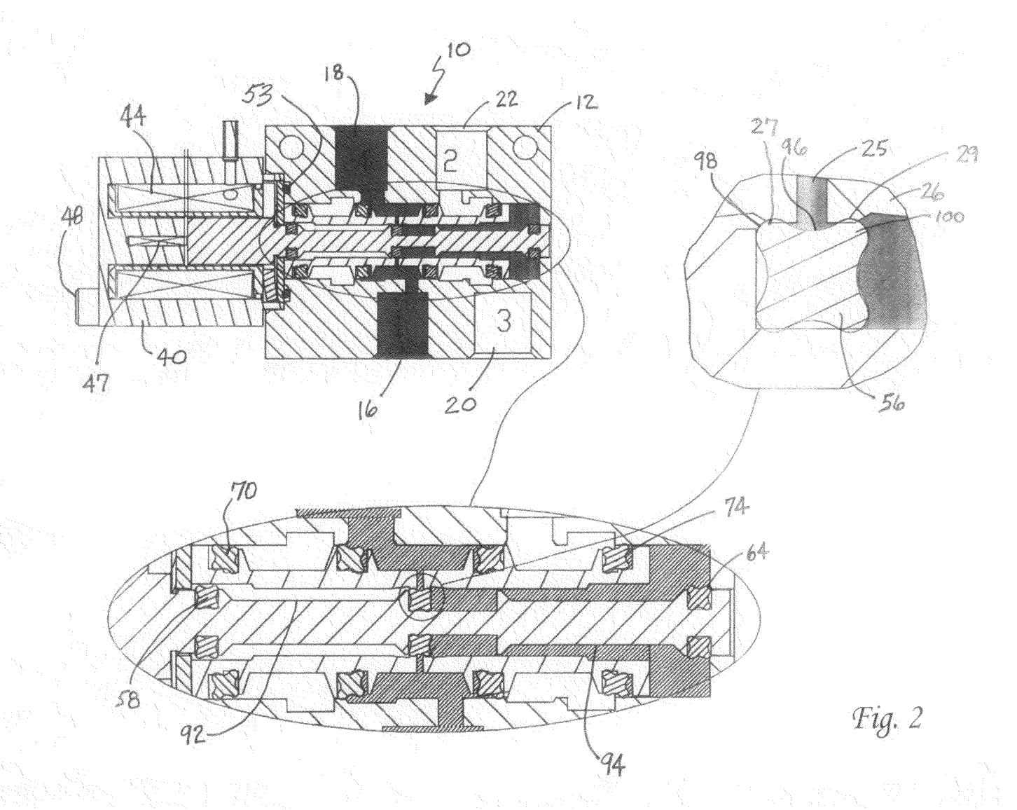

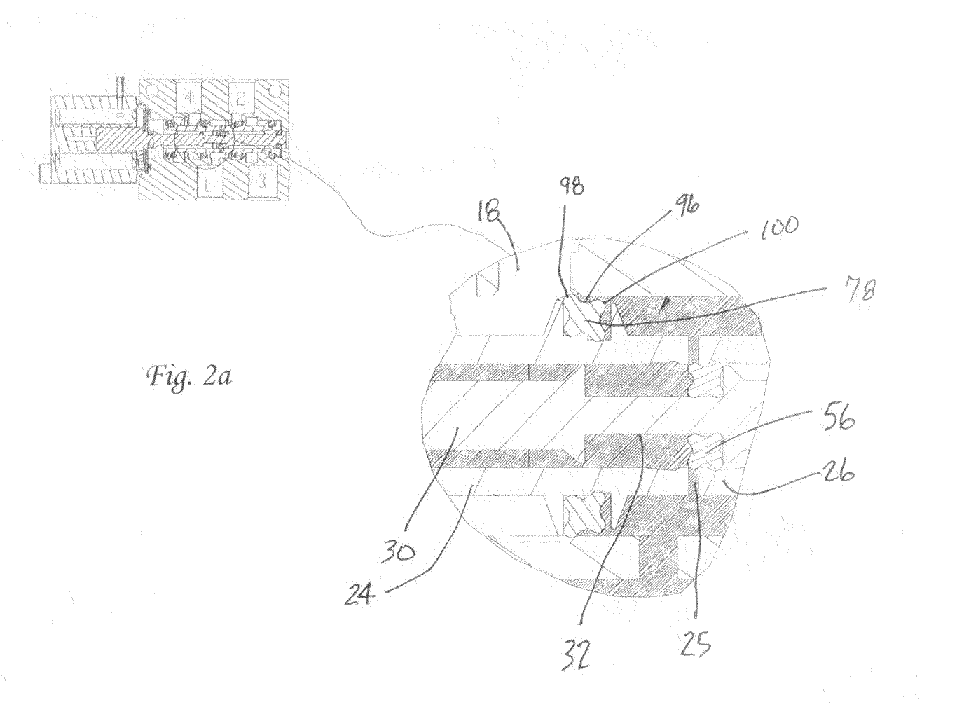

Reference is made to FIGS. 1 and 2 generally illustrating one possible embodiment of the directly piloted valve assembly 10 of the present invention. This is the same valve assembly 10 described in detail in related U.S. provisional patent application Ser. No. 61/102,427, the full disclosure of which is incorporated herein by reference. The piloted valve 10 includes a valve body 12 having a bore 14, a first port 16, a fourth port 18, a third port 20 and a second port 22. Each of the ports 16, 18, 20, 22 is provided in communication with the bore 14. Two screws 21 are received in threaded apertures 23 and may be tightened or loosened to control flow into and out of the valve 10 in a manner known in the art.

A spool 24 is received in the bore 14. The spool 24 includes an outer wall 26 defining a lumen 28. A series of pilot holes 25 are provided in the wall 26. The pilot holes 25 provide fluid communication between the bore 14 in the valve body 20 and the lumen 28 in the spool 24. Radial relief grooves 27, 29 are also provided in the inner surface of the wall 26 on each side of the series of pilot holes 25. The function of these radial relief grooves 27, 29 will be described in detail below.

An actuator 30 is received in the lumen 28. The actuator 30 includes a shuttle seal channel 32 having a first shoulder or end 34 and a second shoulder or end 36. A solenoid, generally designated by reference numeral 38, includes a housing 40 for holding a bobbin 42 and windings 44. The solenoid 38 further includes an armature 45 that is connected to and may be formed as an integral part of the actuator 30. In addition, the solenoid 38 includes the lead wires 46, a return spring 47 and mounting screws 48 for securing the housing 40 of the solenoid to the valve body 12. A coil washer 50, body washer 52, an o-ring 53 and wave spring 54 ensure proper sealing between the housing 40 and the valve body 12.

A shuttle seal 56 is carried on the actuator 30 in the shuttle seal channel 32. The shuttle seal channel 32 may, for example, have a width of between about 0.232 and about 0.236 inches while the shuttle seal 56 has a width of between about 0.057 and about 0.063 inches. A ratio of the shuttle seal channel width to the shuttle seal width is between about 3.75 and about 4.07. Significantly, the shuttle seal 56 is free to move along the actuator 30 in the shuttle seal channel 32 between the first end or shoulder 34 and second end or shoulder 36.

A first actuator end seal 58 is provided in a first channel 60 adjacent a first end 62 of the actuator 30. Similarly, a second actuator end seal 64 is provided in a second channel 66 adjacent a second end 68 of the actuator 30. The actuator ends 62, 68 include straight knurling and function as piloting guides in a manner that will be described in greater detail below.

A first spool end seal 70 is provided in a channel 72 adjacent a first end of the spool 24 while a second spool end seal 74 is provided in a channel 76 adjacent a second end of the spool 24. In addition, a first spool intermediate seal 78 is provided in a channel 80 and a second spool intermediate seal 82 is provided in a channel 84 along the spool 24. A first annular groove 86 is provided in the spool 24 between the first and second spool intermediate seals 78, 82. A second annular groove 88 is provided in the spool 24 between the first spool end seal 70 and the first spool intermediate seal 78. Further, a third annular groove 90 is provided between the second spool end seal 74 and the second spool intermediate seal 82.

A fourth annular groove 92 is provided on the actuator 30 between the first actuator end seal 58 and the shuttle seal channel 32. In addition a fifth annular groove 94 is provided on the actuator 30 between the second actuator end seal 64 and the shuttle seal channel 32.

When the actuator 30 is properly positioned in the lumen 28 of the spool 24 and the spool 24 is properly positioned in the bore 14 of the valve body 12, the pilot holes 25 provide direct fluid communication between the first annular groove 86 in the bore 14 and the shuttle seal channel 32 in the lumen 28. Typically, each of the pilot holes 25 has a diameter of between about 0.015 and about 0.017 inches. Anywhere from three to ten pilot holes 25 may be provided at regular angular intervals about the actuator 30 (e.g. four pilot holes, one every 90°; six pilot holes, one every 60°; ten pilot holes, one every 36°).

As should be appreciated, the actuator 30 is free to shift in the lumen 28 with respect to the spool 24 providing a stroke having a length L₁ of between about 0.012 and about 0.016 inches. Similarly, the spool 24 is free to move in the bore 14 and has a stroke having a length L₂ of between about 0.155 and about 0.165 inches. Typically the ratio of L₂ to L₁ is between about 9.7 and about 13.7. Advantageously, the relatively short actuator stroke minimizes the power requirements for the operation of the valve 10 while the relatively long stroke of the spool results in desirable high flow properties.

As best illustrated in FIGS. 2 and 2a, each of the seals 56, 58, 64, 70, 74, 78 and 82 is a quad ring lobed seal. Each quad ring lobed seal 56, 58, 64, 70, 74, 78 and 82 includes an annular groove 96 provided between adjacent lobes 98 and 100. As will become apparent in the following description, whether the valve 10 is in the first operating (fully energized) position or the second, opposite operating (fully de-energized) position, the groove 96 on the shuttle seal 56 is aligned with the pilot holes 25. Further, it should be appreciated that the quad ring lobed seals 70, 74, 78 and 82 on the spool 24 are assembled in tension so as to be pulled toward the center of the spool, causing one lobe to be at a larger outside diameter than the other.

Operation of the valve 10 will now be described in detail with reference to FIGS. 2, 3, 4a, 4b, 5a, 5b and 5c. FIG. 2 illustrates the valve 10 in the second or un-energized position. In this position the first or input port 16 is in communication with the fourth or output port 18 while the second port 22 is provided in communication with the third or exhaust port 20. As illustrated, the shuttle seal 56 is at the first end or shoulder 34 of the shuttle seal channel 32 with the groove 96 of that seal aligned with the pilot holes 25. The actuator 30 is biased to the right in the drawing figure by operation of the return spring 47 so that the second actuator end seal 64 seals against the valve body 12 while the first end knurled piloting guide 62 is opened to atmosphere so as to provide for its piloting function. As should be appreciated, the pressurized fluid in the bore 14 forces the spool 24 as far as possible to the left thereby opening the fourth port 18 to the pressurized fluid running from first port 16 through the bore 14 while the seals 74, 78 and 82 close off the second port 22.

As should further be appreciated from reviewing drawing FIG. 2, pressurized fluid in the bore 14 also flows through the pilot holes 25 into the annular groove 96 of the shuttle seal 56. Since the volume or space in the bore 14 to the left of the lobe 98 is open to atmosphere by the first end knurled piloting guide 62, the lobe 98 forms a tight seal against the inner surface of the wall 26 of the lumen 28 and pressurized fluid cannot pass to the left. Since the volume or space in the bore 14 to the right of the lobe 100 is closed to atmosphere by the second end seal 64 and the volume to the left and to the right of lobe 100 is pressurized at the same pressure, lobe 100 does not seal and the pressurized fluid flows past the lobe 100 at surface of lumen 28 to the right end of the bore 14 where it forces the spool 24 to the left and holds it in position at the left end of the bore 14.

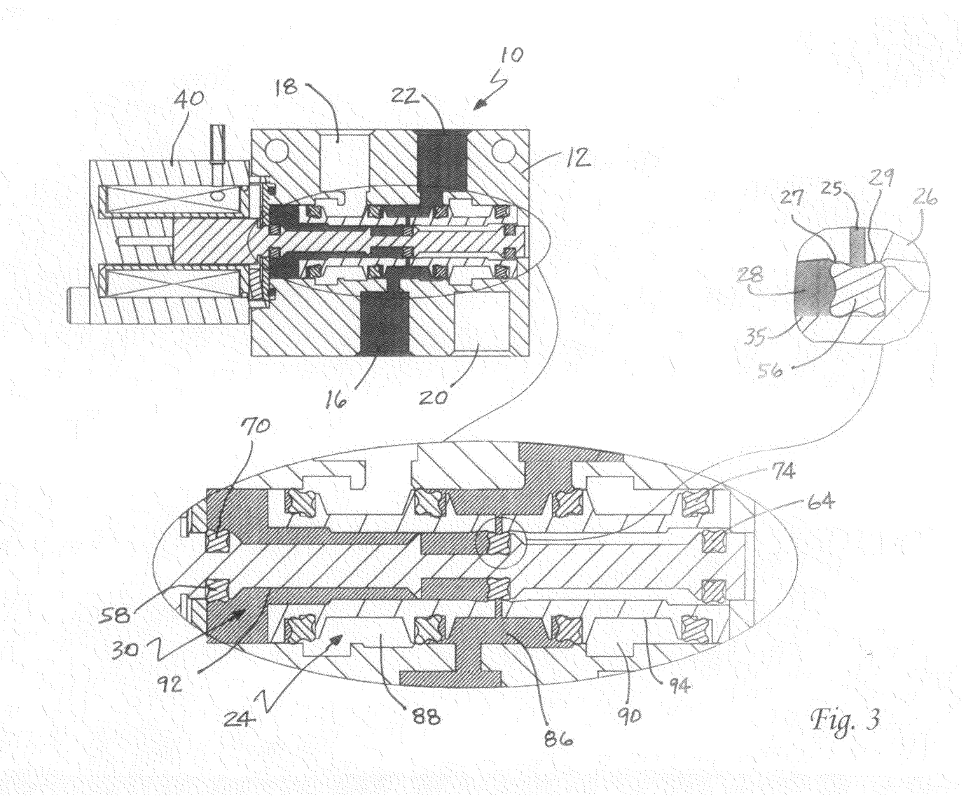

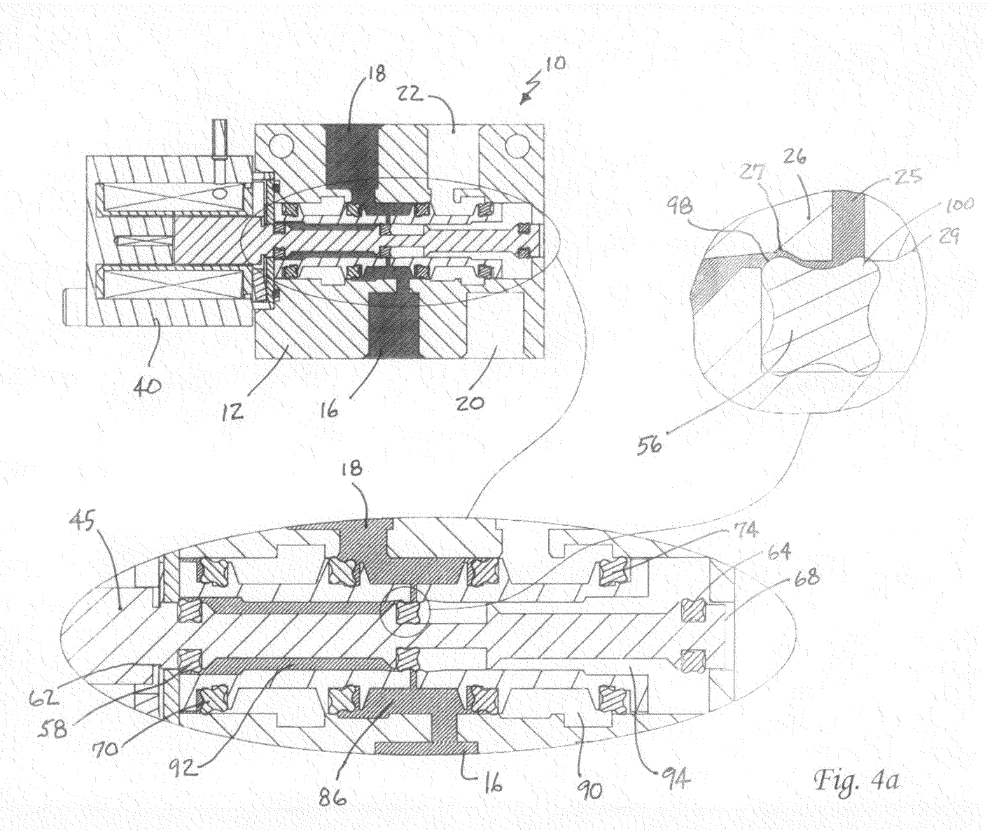

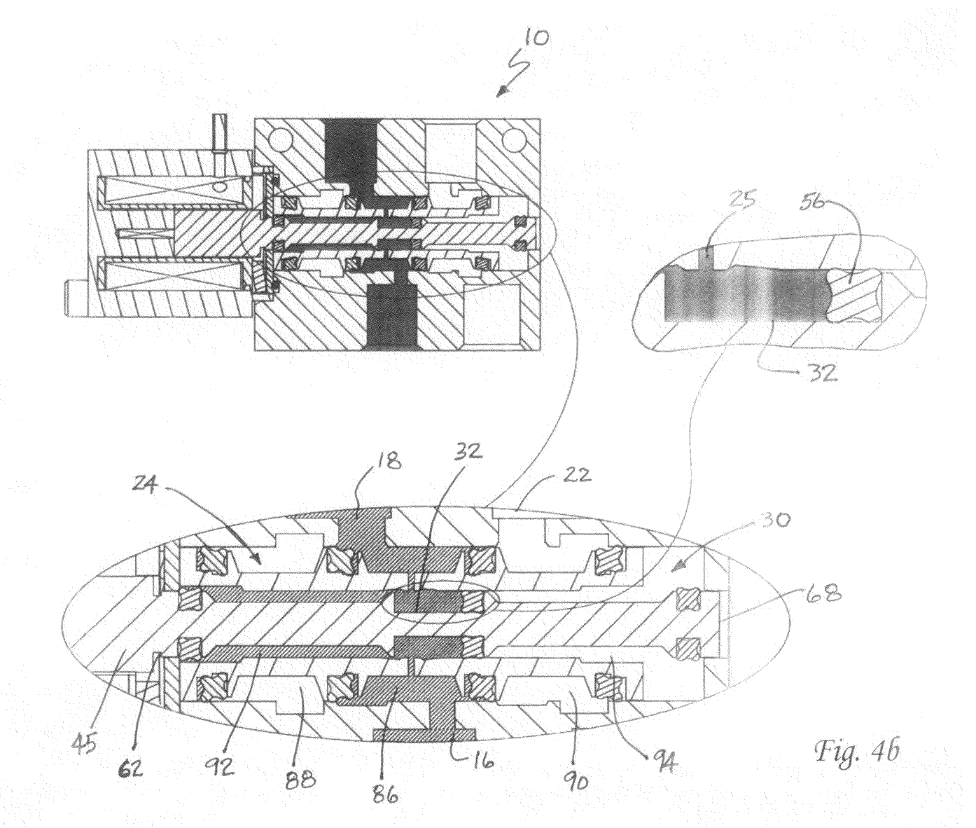

When the solenoid 38 is energized, the coil windings 44 draw the armature 45/actuator 30 to the left in the drawing FIG. 4a. As a result, the first actuator end seal 58 seals against the body washer 52, at the same time the second actuator end seal 64 is moved away from the valve body 12 opening a passage around the seal to the second end knurled piloting guide 68 open to atmosphere. This pressure change causes lobe 100 of the shuttle seal 56 to seal against the surface of lumen 28 and lobe 98 of seal 56 moves to the left into relief groove 27 thereby allowing the pressurized fluid to move from the groove 96 past the lobe 98 through the radial relief groove 27 to the left side of the bore 14 (see FIG. 4a). Next, the shuttle seal 56 moves from the first shoulder or end 34 to the second shoulder or end 36 of the shuttle seal channel 32 further opening the pilot holes 25 (see FIG. 4b). The pressurized fluid then flows from the fourth annular groove 92 past the first actuator end seal 58 toward the body washer 52 where it forces its way between the body washer and the first end of the spool 24 causing the spool to move fully to the right (compare FIG. 4b and FIG. 3). As this occurs, the seal 78 closes off the fourth port 18 to the pressurized fluid and opens it to the third or exhaust port 20. Seal 70 always maintains a seal with bore 14. Simultaneously, the first annular groove 86 is brought into communication with the second port 22 so that the pressurized fluid flows from the first or supply port 16 to the second port 22 by way of the first annular groove 86.

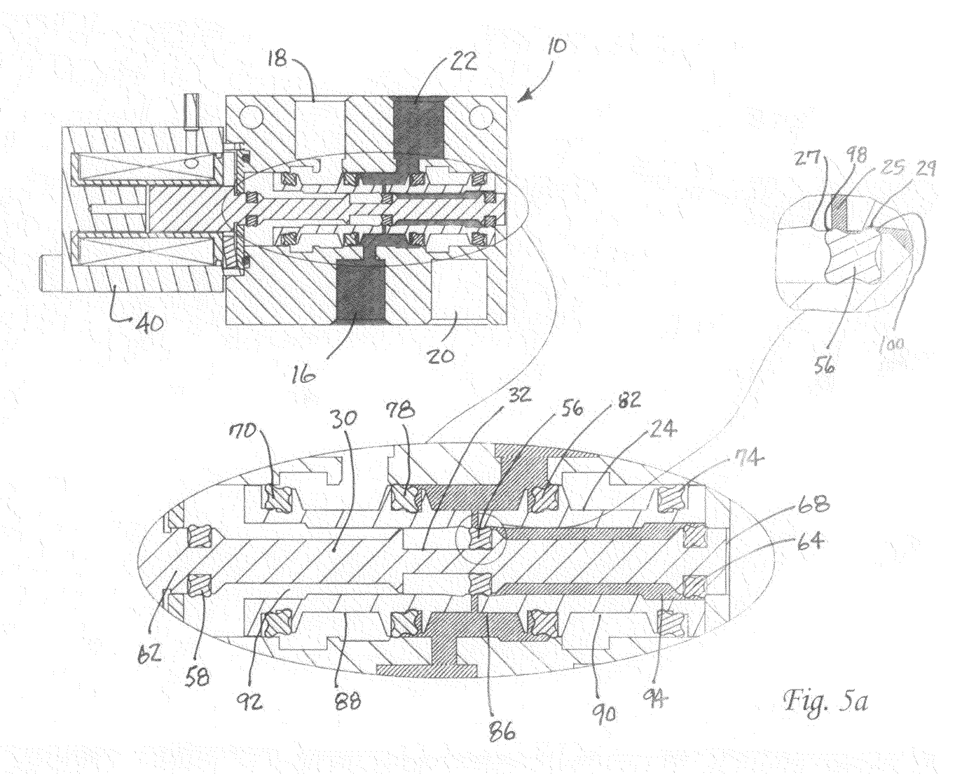

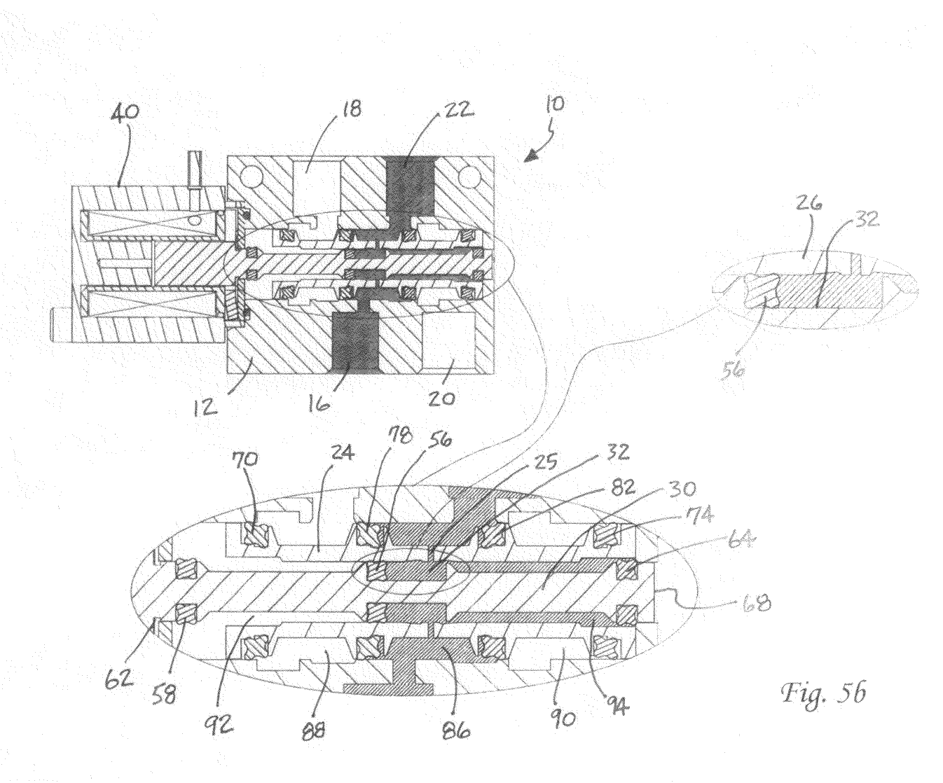

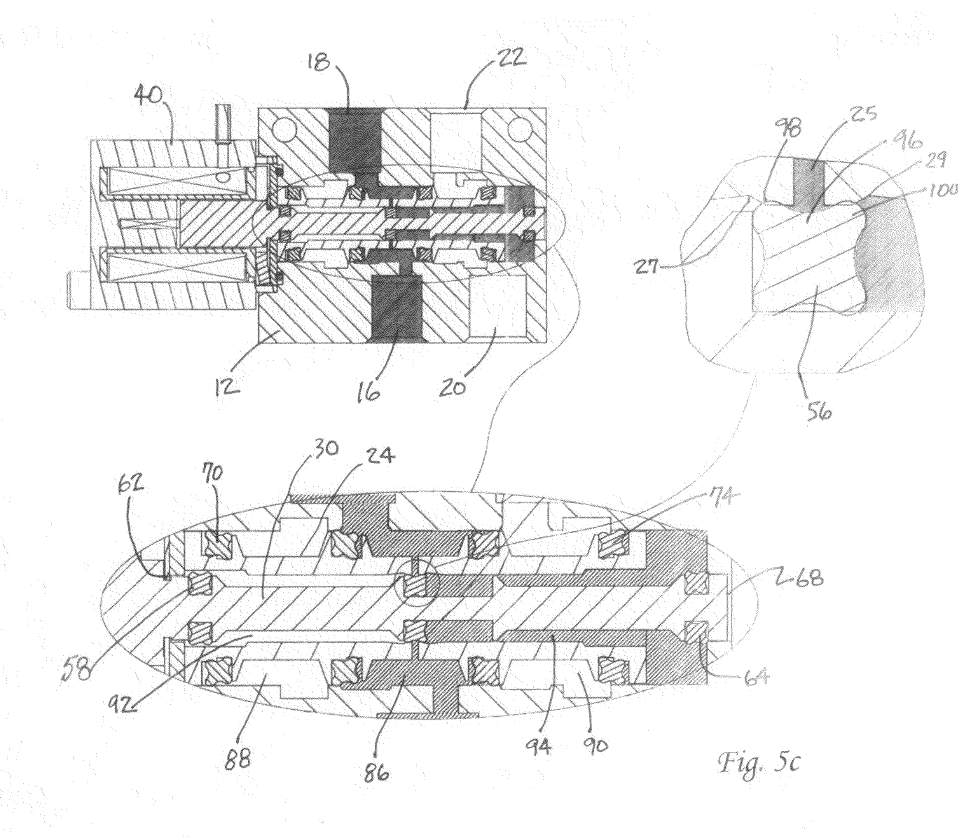

When the solenoid 38 is subsequently de-energized, the return spring 47 biases the armature 45/actuator 30 toward the right end of the valve body 12 so that the second actuator end seal 64 seals against the valve body 12 and the first actuator end seal 58 moves away from the body washer 52 opening a passage around the seal to the first end piloting guide 62 open to atmosphere. This pressure change causes the lobe 98 to seal against the surface of lumen 28 so that pressurized fluid flowing through the pilot holes 25 into the groove 96 flows through the radial relief groove 29 past the lobe 100 into the fifth annular groove 94 at the right end of the valve body 12 (see FIG. 5a). Next, as illustrated in FIG. 5b, the shuttle seal 56 moves from the second shoulder or end 36 to the first shoulder or end 34 of the shuttle seal channel 32 thereby fully opening the pilot holes 25. The pressurized fluid then flows from the fifth annular groove 94 past the seal 64 to the end wall of the valve body 12 forcing the spool 24 away from that wall to the left end of the bore 14 (compare FIG. 5b and FIG. 2). As this occurs, the first annular groove 86 is opened to the fourth port 18 so that pressurized fluid from the first or supply port 16 flows through the first annular groove 86 to the fourth port 18. Simultaneously, the seal 82 seals pressurized fluid off from the second port 22 which is provided in communication with the third or exhaust port 20 through the third annular groove 90.

Numerous benefits result from employing the concepts of the present invention. As described above, the present invention makes use of quad ring lobe seals 56, 58, 64, 70, 74, 78 and 82. Further these seals are assembled in tension. This results in a number of significant advantages over prior art valve designs. More specifically, prior art valve designs typically incorporate o-ring or oval shaped seals. It has been found necessary to provide six seals of the o-ring or oval shape in order to provide a closed cross over design to prevent the extrusion of a seal into a bore that could otherwise cause pinching and cutting failure during shifting of the spool. As only four spool seals are required when utilizing the quad rind lobe seals of the present invention production costs are reduced and a shorter overall spool may be provided with the same or greater flow capability than a valve using six seals on the spool as, only found in the prior art. More specifically, the quad ring lobe seals do not extrude under pressure during shifting of the spool because the seals are assembled under tension so that the main body is pulled in towards the spool center and because air pressure is forcing the body of the quad ring seal also toward the center of the spool thereby preventing extrusion into the gap during the shifting of the spool.

Also of significance, quad ring lobe seals do not include a molded parting line along the sealing surface as is common of o-rings and oval shaped seals. As a consequence, the quad ring lobe seals used in the present invention provide a smooth sealing surface that requires less interference to effect a seal. As a consequent benefit, there is less of a tendency for the quad ring lobe seals to extrude into the bore where they could become damaged. Further, quad ring lobe seals as provided in the present invention are not subject to spiral/rolling failure characteristic of some o-rings.

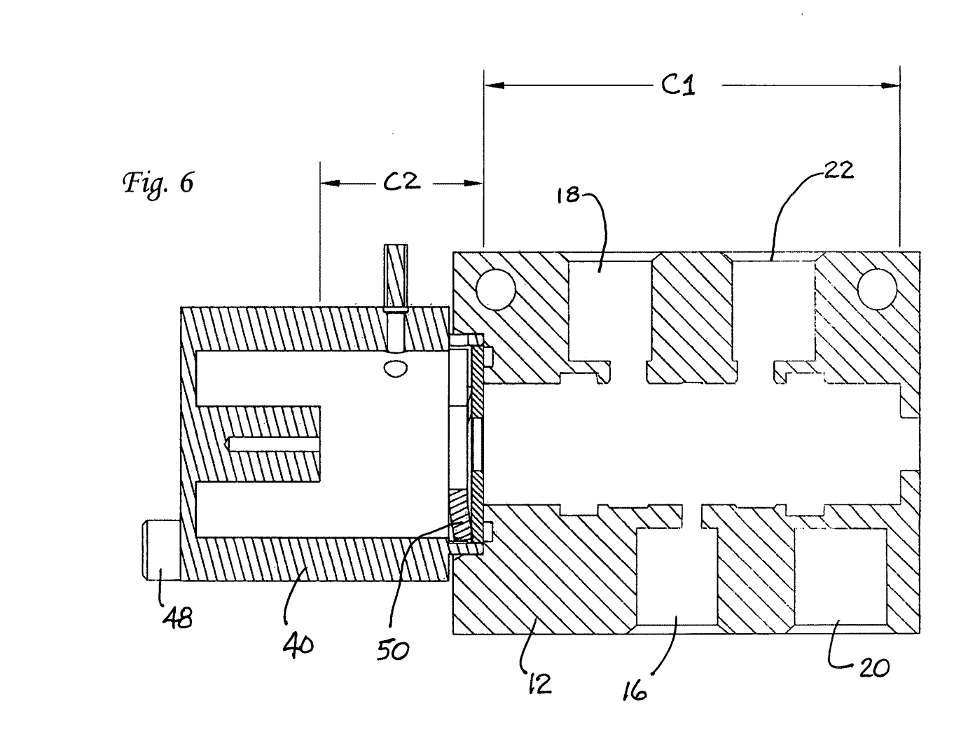

As best illustrated in FIG. 6, the valve assembly 10 of the present invention includes two critical dimensions C1 and C2. Critical dimension C1 relates to controlling the spool and actuator strokes while critical dimension C2 relates to controlling coil gap and actuator stroke. Both of these features can be machined to tight tolerance because they can be completed with a custom one piece forming tool thereby ensuring optimum performance and product integrity of the valve assembly 10 of the present invention.

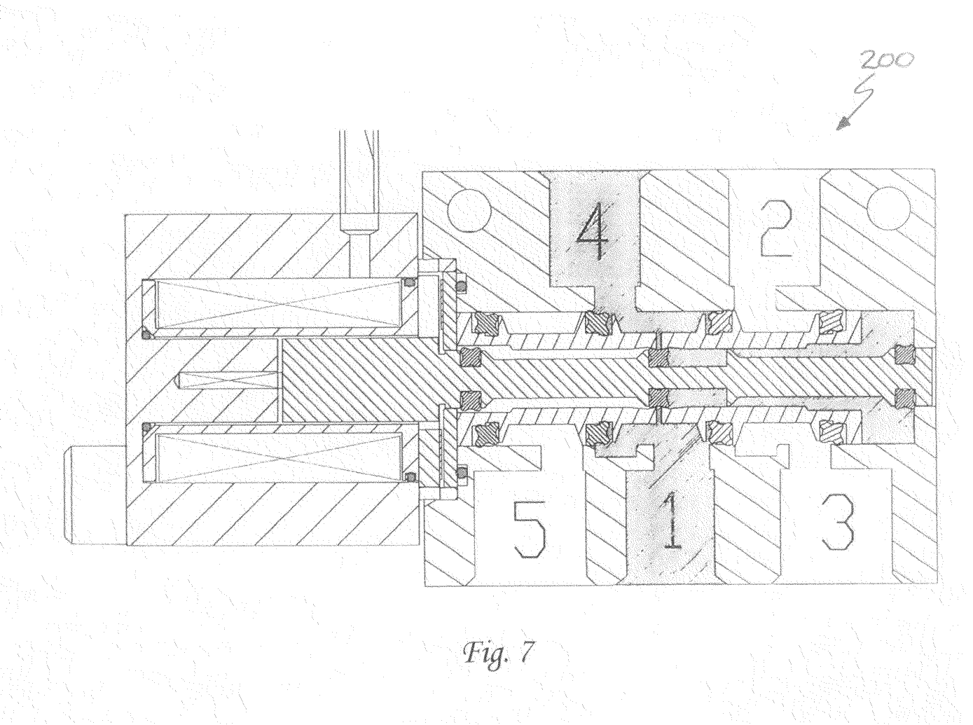

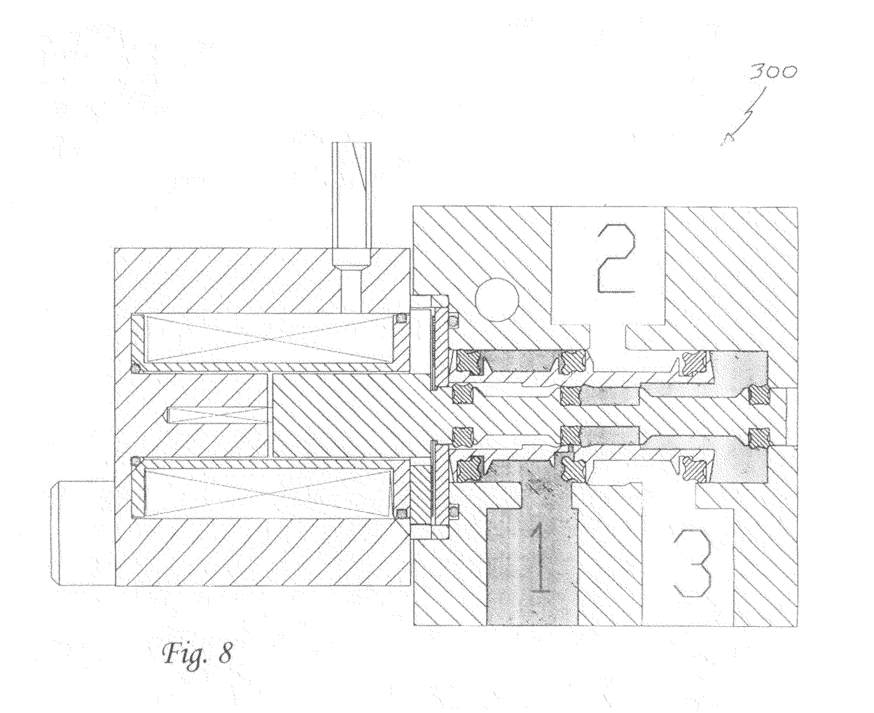

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, FIG. 7 illustrates a 4-way, 5 ported directly piloted valve 200 constructed in accordance with the teachings of the present invention. FIG. 8 illustrates a 3-way, normally closed, directly piloted valve 300 constructed in accordance with the teachings of the present invention. The complexity and cost of producing the valve body 12 can be reduced by machining a smooth bore 14 and using one or more inserts to create the functional geometry. Similarly, functional geometry may be moved from the inner surface of the spool 24 to the outer surface of the actuator 30 to reduce manufacturing costs and allow for more efficient quality control inspection. Further, the coil housing 40 could be made as a round part with a base that will fit inside the valve body 12 to further reduce manufacturing and assembly costs.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A directly piloted valve assembly, comprising:
a valve body including a bore, at least one inlet port, at least one outlet port, and at least one exhaust port wherein said ports are all in fluid communication with said bore;
a spool received in said bore, said spool including a wall defining a lumen;
an actuator received in said lumen, said actuator including a shuttle seal channel;
a shuttle seal received in said shuttle seal channel; and
a solenoid connected to said valve body;
said wall including at least one pilot hole in fluid communication with said lumen and said bore.

2. The valve assembly of claim 1, wherein said shuttle seal translates along said actuator between a first end and a second end of said shuttle seal channel.

3. The valve assembly of claim 2, wherein said at least one pilot hole is aligned with said shuttle seal channel.

4. The valve assembly of claim 1, wherein said channel has a first width of between about 0.236 and about 0.232 inches and said shuttle seal has a second width of between about 0.063 and about 0.057 inches and a ratio of said first width to said second width is between about 3.68 and about 4.14.

5. The valve assembly of claim 1, wherein said solenoid includes a coil and a return spring held in a housing and an armature connected to said actuator.

6. The valve assembly of claim 1, wherein said actuator includes a first actuator end seal held in a first end channel on a first side of said shuttle seal channel and a second actuator end seal held in a second end channel on a second side of said shuttle seal channel.

7. The valve assembly of claim 6, wherein said first and second actuator end seals are quad ring lobed seals assembled under tension so that an outside diameter of said quad ring lobed seals are enlarged.

8. The valve assembly of claim 6, wherein said spool includes a first spool end seal, a second spool end seal, a first spool intermediate seal and a second spool intermediate seal.

9. The valve assembly of claim 8, wherein a first annular groove is provided in said spool between said first and second spool intermediate seals, a second annular groove is provided in said spool between said first spool end seal and said first spool intermediate seal and a third annular groove is provided between said second spool end seal and second spool intermediate seal.

10. The valve assembly of claim 9, wherein said at least one pilot hole provides communication between said lumen at said shuttle seal channel and said bore at said first annular groove.

11. The valve assembly of claim 10 wherein said at least one pilot hole has a diameter of between about 0.017 and about 0.015.

12. The valve assembly of claim 1, wherein said actuator has a first stroke having a length L1 and said spool has a second stroke of a length L2 where L2 is greater than L1.

13. The valve assembly of claim 12, wherein a ratio of L2 to L1 is between about 13.7 and about 9. 7.

14. The valve assembly of claim 1, wherein said shuttle seal is a quad ring lobed seal.

15. The valve assembly of claim 14, wherein said quad ring lobed seal includes an annular groove, between lobes, aligned with said at least one pilot hole when said spool and said actuator are in a first operating position and a second, opposite operating position.

16. The valve assembly of claim 15, further including two radial relief grooves in said actuator wall and communicating with said lumen, one relief groove of said two radial relief grooves being provided on each side of said pilot hole so that said shuttle quad ring lobed seal is also axially centered between said two radial relief grooves when said spool and said actuator are at said first and second operating positions.

17. The valve assembly of claim 14, wherein said first spool end seal, said second spool end seal, said first spool intermediate seal and said second spool intermediate seal are all quad ring lobed seals.

18. The valve assembly of claim 17, wherein said quad ring lobed seals on said spool are in tension on said spool so as to be pulled toward said center of said spool.

19. The valve assembly of claim 17, wherein said quad ring lobed seals on said spool are in tension on said spool such that the two outer lobes are at different diameters.

20. The valve assembly of claim 18, including a fourth annular groove on said actuator between said first actuator end seal and said shuttle seal channel and a fifth annular groove on said actuator between said second actuator end seal and said shuttle seal channel.

21. The valve assembly of claim 20, including piloting guides at two ends of said actuator to allow air to pass to atmosphere.
